(19) United States
(12) Patent Application Publication
(10) Pub. No.: US 2012/0044946 A1
(43) Pub. Date: Feb. 23, 2012

(54) ROUTER AND METHOD OF PASSING IPV6 DATA PACKETS THROUGH THE ROUTER

(75) Inventor: YA-FEN ZHANG, Shanghai (CN)

(73) Assignees: HON HAI PRECISION INDUSTRY CO., LTD., Tu-Cheng (TW); AMBIT MICROSYSTEMS (SHANGHAI) LTD., SHANGHAI (CN)

(21) Appl. No.: 12/910,843

(22) Filed: Oct. 24, 2010

(30) Foreign Application Priority Data
Aug. 17, 2010 (CN) 201010255592.3

(51) Int. Cl. H04L 12/56

(52) U.S. Cl. 370/401

(57) ABSTRACT

In a router and a method of passing IPv6 data packets through the router, the router receives a data packet from a local area network or the wide area network. The router determines if the data packet is a IPv6 data packet or a non-IPv6 data packet . The router routes the data packet to a destination address via the network layer of the open system interconnect, upon the condition that the data packet is a non-IPv6 data packet; or bridges the data packet to the destination address via the data link layer, upon the condition the data packet is a IPv6 data packet.

### BACKGROUND

1. Technical Field

The present disclosure relates to network communications, and more particularly to a router and a method of passing IPv6 data packets through the router.

2. Description of Related Art

The IPv4 network communication protocol is widely used in traditional Internet protocol (IP) networks. However, shortcomings of the IPv4 network communication protocol have emerged. One of the most serious and urgent shortcomings are that IP addresses will soon all be allocated and routing tables in current routers are excessively huge, which directly brings a next generation Internet protocol, namely IPv6 network communication protocol, to birth.

However, the basic architecture of IPv4 network is still implemented widely and the number of IPv4 related apparatuses is numerous. For example, many routers can only communicate with other network devices with the IPv4 protocol. Therefore, a heretofore unaddressed need exists for routers that can overcome the limitations existing in using the IPv6 protocol.

### BRIEF DESCRIPTION OF THE DRAWINGS

The details of the disclosure, both to its structure and operation, can best be understood by referring to the accompanying drawings, in which like reference numbers and designations refer to like elements.

FIG. 1 is an application environment and a schematic diagram of functional modules of one embodiment of a router of the present disclosure.

FIG. 2 is an example of first rules of processing a non-IPv6 data packet.

FIG. 3 is a flowchart of one embodiment of a method of passing IPv6 data packets through the router of FIG. 1.

### DETAILED DESCRIPTION

The application is illustrated by way of examples and not by way of limitation in the figures of the accompanying drawings in which like references indicate similar elements. It should be noted that references to “an” or “one” embodiment in this disclosure are not necessarily to the same embodiment, and such references mean at least one.

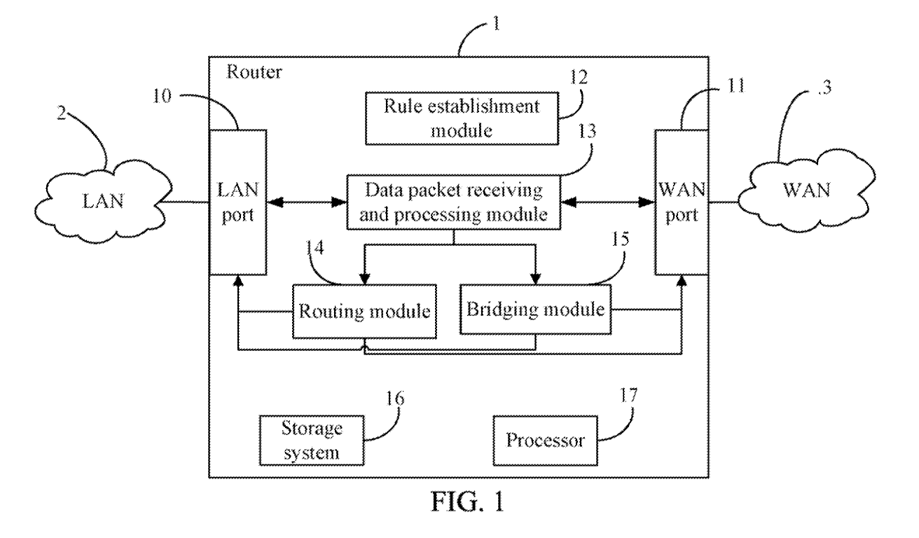

FIG. 1 is an application environment and a schematic diagram of functional modules of one embodiment of a router 1 of the present disclosure. In one embodiment, the router 1 includes at least one local area network (LAN) port 10 and at least one wide area network (WAN) port 11. The at least one LAN port 10 may include at least one wireless LAN port and/or at least one wired LAN port (not shown). The router 1 is connected to a LAN 2 and a WAN 3 by way of the LAN port 10 and the WAN port 11, respectively. The router 1 is operable to forward IPv4 and/or IPv6 data packets between the LAN 2 and the WAN 3 by the LAN port 10 and the WAN port 11.

In some embodiments, the router 1 includes function modules of a rule establishment module 12, a data packet receiving and processing module 13, a routing module 14, and a bridging module 15. The function modules 12-15 may be comprised of one or more computerized codes in the form of one or more programs that are stored in a storage system 16. The storage system 16 may include high speed random access memory and may also include non-volatile memory, such as one or more magnetic disk storage devices, flash memory devices, or other non-volatile solid state memory devices. The one or more computerized codes include instructions that are executed by at least one processor 17, to provide functions for the function modules.

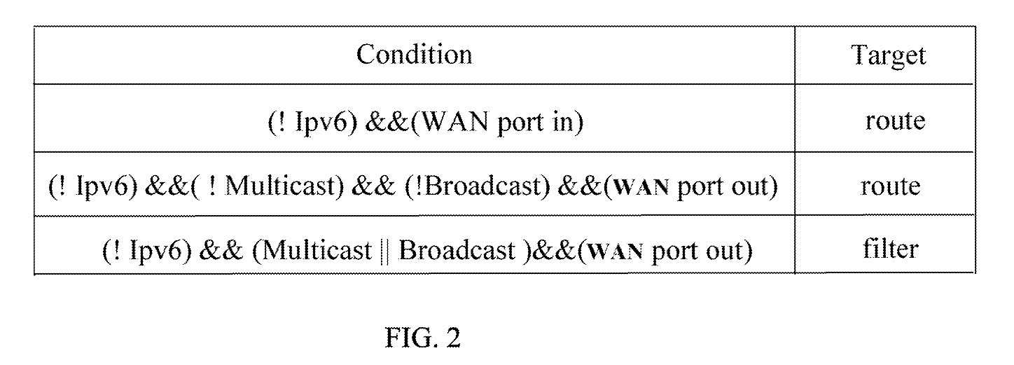

The rule establishment module 12 establishes first rules of the router 1 for processing non-IPv6 data packets, and stores the first rules into the storage system 16. It may be appreciated that, the non-IPv6 data packets may be IPv4 data packets. In some embodiments, referring to FIG. 2, the first rules include:

1. If a non-IPv6 data packet (!IPv6) is from the WAN port 11 (WAN port in), the router 1 routes the non-IPv6 data packet to a destination address via the network layer of the open system interconnect (OSI).
2. If a non-IPv6 data packet (!IPv6) is to the WAN port 11 (WAN port out), but the non-IPv6 data packet is neither a multicast (!Multicast) data packet nor a broadcast (!Broadcast) data packet, the router 1 still routes the non-IPv6 data packet to a destination address via the network layer of the OSI.
3. If a non-IPv6 data packet (!IPv6) is to the WAN port 11 (WAN port out), and the non-IPv6 data packet is a multicast data packet or a broadcast (Multicast∥Broadcast) data packet, the router 1 filters the non-IPv6 data packet.

In some embodiments, the rule establishment module 12 may further establish second rules of the router 1 for processing IPv6 data packets according to user demands, and stores the second rules into the storage system 16. In some embodiments, the second rules may include, but not limited to, for example, passing unicast data packets to the wireless LAN port 10, while filtering multicast data packets, passing internet control message protocol (ICMP) data packets, while filtering user datagram protocol (UDP) data packets. In other embodiments, the rule establishment module 12 may not establish the second rules at all.

The data packet receiving and processing module 13 receives a data packet from the LAN 2 or the WAN 3, determines if the data packet is a IPv6 data packet or a non-IPv6 data packet according to an ether type included in the data packet, filters the non-IPv6 data packet or passes the non-IPv6 data packet to the routing module 15 according to the first rules stored in the storage system 16, and filters the IPv6 data packet or passes the IPv6 data packet to the bridging module 15 according to the second rules stored in the storage system 16. It may be appreciated that the data packet consists of two kinds of data: control information and user data. The control information provides data the network needs to deliver the user data, for example: the ether type of the user data, source and destination addresses.

The routing module 14 provides a routing functionality of routing the non-IPv6 data packet to a destination address via the network layer of the OSI.

The bridging module 15 provides a bridging functionality of bridging the IPv6 data packet to a destination address via the data link layer of the OSI, to realize passing the IPv6 data packet through the router 1. In some embodiments, the bridging functionality of the bridge module 14 is enabled by tying the LAN port 10 and the WAN port 11 to a Bridge.

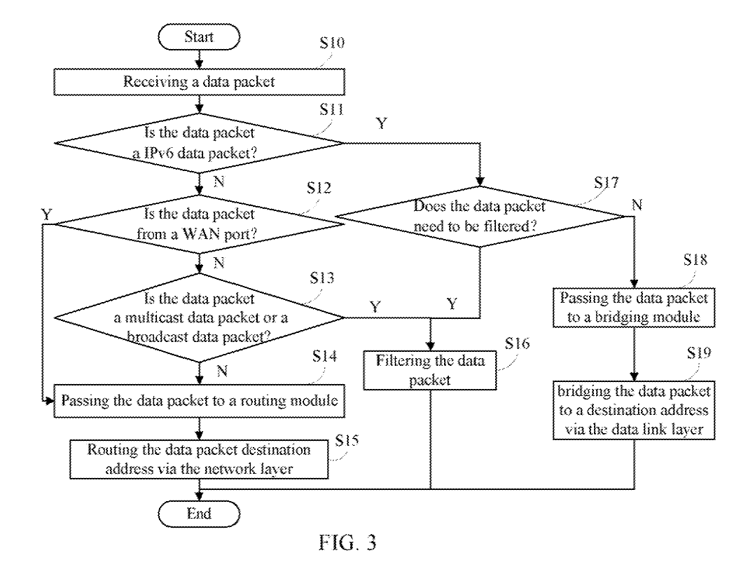

FIG. 3 is a flowchart of one embodiment of a method of passing IPv6 data packets through the router 1. The method being performed by execution of computer readable program codes by the processor 17 of the router 1. Depending on the embodiment, additional blocks in the flow of FIG. 3 may be added, others removed, and the ordering of the blocks may be changed.

In block S10, the data packet receiving and processing module 13 of the router 1 receives a data packet from the LAN 2 or the WAN 3. As mentioned above, the router 1 connects with the LAN 2 and the WAN 3 by way of the LAN port 10 and the WAN port 11 thereof.

In block S11, the data packet receiving and processing module 13 determines if the data packet is a IPv6 data packet or a non-IPv6 data packet according to an ether type of the data packet. If the data packet is a non-IPv6 data packet, block S12 is implemented. Otherwise, block S17 is implemented if the data packet is a IPv6 data packet.

In block S12, the data packet receiving and processing module 13 determines whether the non-IPv6 data packet is from the WAN port 11. Block S13 is implemented, if the non-IPv6 data packet is not from the WAN port 11, but is to the WAN port 11. Otherwise, block S14 is implemented if the non-IPv6 data packet is from the WAN port 11.

In block S13, the data packet receiving and processing module 13 further determines whether the non-IPv6 data packet is a multicast data packet or a broadcast data packet. Block S14 is implemented, if the non-IPv6 data packet is neither a multicast data packet nor a broadcast data packet. Otherwise, block S16 is implemented, if the non-IPv6 data packet is a multicast data packet or a broadcast data packet.

In block S14, the data packet receiving and processing module 13 passes the non-IPv6 data packet to the routing module 14 according to first rules pre-established and stored in the storage system 16, and in block S16, the data packet receiving and processing module 13 filters the non-IPv6 data packet according to the first rules. The first rules are established by a rule establishment module 12 of the router 1. As mentioned above, in some embodiments, referring to FIG. 2, the first rules include:

1. If a non-IPv6 data packet (!IPv6) is from the WAN port 11 (WAN port in), the router 1 routes the non-IPv6 data packet to a destination address via the network layer of the open system interconnect (OSI).
2. If a non-IPv6 data packet (!IPv6) is to the WAN port 11 (WAN port out), but the non-IPv6 data packet is neither a multicast (!Multicast) data packet nor a broadcast (!Broadcast) data packet, the router 1 still routes the non-IPv6 data packet to a destination address via the network layer of the OSI.
3. If a non-IPv6 data packet (!IPv6) is to the WAN port 11 (WAN port out), and the non-IPv6 data packet is a multicast data packet or a broadcast (Multicast∥Broadcast) data packet, the router 1 filters the non-IPv6 data packet.

Block S15 is implemented after block S14. In block S15, the routing module 14 routes the non-IPv6 data packet to a destination address via the network layer of the OSI.

In block S17, the data packet receiving and processing module 13 further determines whether the IPv6 data packet needs to be filtered according to second rules stored in the storage system 16. The second rules are also established by the rule establishment module 12 of the router 1. As mentioned above, the second rules may include, but not limited to, for example, passing unicast data packets to wireless LAN port 10, while filtering multicast data packets, passing internet control message protocol (ICMP) data packets, while filtering user datagram protocol (UDP) data packets. If there is a need to filter the IPv6 data packet according to the second rules, block S16 is implemented. Otherwise, if the second rules do not exist in the storage system 16, or there is no need to filter the IPv6 data packet according to the second rules, block S18 is implemented.

In block S16, the data packet receiving and processing module 13 filters the IPv6 data packet according to the second rules, and in block S18, the data packet receiving and processing module 13 passes the IPv6 data packet to the bridging module 15 according to the second rules.

Block S19 is implemented after block S18, in which, the bridging module 15 bridges the IPv6 data packet to a destination address via the data link layer of the OSI, to realize the IPv6 data packet passing through the router 1.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A method of passing IPv6 data packets through a router, wherein the router is connected to a local area network (LAN) and a wide area network (WAN) by way of a LAN port and a WAN port of the router, the method comprising:
(a) receiving a data packet by the router from the LAN or the WAN;
(b) determining if the data packet is a non-IPv6 data packet or a IPv6 data packet;
(c) routing the data packet to a destination address via the network layer of the open system interconnect (OSI), upon the condition that the data packet is a non-IPv6 data packet; or
(d) bridging the data packet to the destination address via the data link layer of the OSI, upon the condition the data packet is a IPv6 data packet, to realize passing the IPv6 data packet through the router.

2. The method as described in claim 1, before (a) further comprising:
(e) establishing first rules of the router for processing the non-IPv6 data packet, and storing the first rules into a storage system of the router, wherein the first rules comprise:
(1). If the non-IPv6 data packet is from the WAN port of the router, the router routes the non-IPv6 data packet;
(2). If the non-IPv6 data packet is to the WAN port, but the non-IPv6 data packet is neither a multicast data packet nor a broadcast data packet, the router routes the non-IPv6 data packet; and
(3). If the non-IPv6 data packet is to the WAN port, and the non-IPv6 data packet is a multicast data packet or a broadcast data packet, the router filters the non-IPv6 data packet.

3. The method as described in claim 2, wherein step (c) further comprises:
filtering the data packet according to the first rules.

4. The method as described in claim 1, wherein the LAN port of the router is a wireless LAN port or a wired LAN port.

5. The method as described in claim 4, before (a) further comprising:
(f) establishing second rules of the router for processing the IPv6 data packet, and storing the second rules into a storage system of the router, wherein the second rules comprise: passing unicast data packets to the wireless LAN port, while filtering multicast data packets, passing internet control message protocol (ICMP) data packets, while filtering user datagram protocol (UDP) data packets.

6. The method as described in claim 5, wherein step (d) further comprises:
filtering the data packet according to the second rules.

7. The method as described in claim 1, wherein the bridging functionality in step (d) is enabled by tying the LAN port and the WAN port of the router to a Bridge.

8. A non-transitory storage medium having stored thereon instructions that, when executed by a processor, cause the processor to perform a method of passing IPv6 data packets through a router, wherein the router is connected to a local area network (LAN) and a wide area network (WAN) by way of a LAN port and a WAN port of the router, the method comprising:
(a) receiving a data packet by the router from the LAN or the WAN;
(b) determining if the data packet is a non-IPv6 data packet or a IPv6 data packet;
(c) routing the data packet to a destination address via the network layer of the open system interconnect (OSI), upon the condition that the data packet is a non-IPv6 data packet; or
(d) bridging the data packet to the destination address via the data link layer of the OSI, upon the condition the data packet is a IPv6 data packet, to realize the IPv6 data packet passing through the router.

9. The non-transitory storage medium as described in claim 8, before (a) the method further comprising:
(e) establishing first rules of the router for processing the non-IPv6 data packet, and storing the first rules into a storage system of the router, wherein the first rules comprise:
(1). If the non-IPv6 data packet is from the WAN port of the router, the router routes the non-IPv6 data packet;
(2). If the non-IPv6 data packet is to the WAN port, but the non-IPv6 data packet is neither a multicast data packet nor a broadcast data packet, the router routes the non-IPv6 data packet; and
(3). If the non-IPv6 data packet is to the WAN port , and the non-IPv6 data packet is a multicast data packet or a broadcast data packet, the router filters the non-IPv6 data packet.

10. The non-transitory storage medium as described in claim 9, wherein step (c) further comprises:
filtering the data packet according to the first rules.

11. The non-transitory storage medium as described in claim 8, wherein the LAN port of the router is a wireless LAN port or a wired LAN port.

12. The non-transitory storage medium as described in claim 11, before (a) further comprising:
(f) establishing second rules of the router for processing the IPv6 data packet, and storing the second rules into a storage system of the router, wherein the second rules comprise: passing unicast data packets to the wireless LAN port, while filtering multicast data packets, passing internet control message protocol (ICMP) data packets, while filtering user datagram protocol (UDP) data packets.

13. The non-transitory storage medium as described in claim 12, wherein step (d) further comprises:
filtering the data packet according to the second rules.

14. The non-transitory storage medium as described in claim 8, wherein the bridging functionality in step (d) is enabled by tying the LAN port and the WAN port of the router to a Bridge.

15. A router, comprising:
a local area network (LAN) port and a wide area network (WAN) port, which connect with a LAN and a WAN, respectively;
a storage system;
at least one processor;
one or more programs that are stored in the storage system and are executed by the at least one processor, the one or more programs comprising:
a data packet receiving and processing module operable to receive a data packet from the LAN or the WAN, and determines if the data packet is a non-IPv6 data packet or a IPv6 data packet;
a routing module operable to provide a routing functionality of routing the data packet to a destination address via the network layer of the open system interconnect (OSI), upon the condition that the data packet is a non-IPv6 data packet; or
a bridging module operable to provide a bridging functionality of bridging the data packet to the destination address via the data link layer of the OSI, upon the condition the data packet is a IPv6 data packet, to realize the IPv6 data packet passing through the router.

16. The router as described in claim 15, further comprising:
a rule establishment module operable to establish first rules of the router for processing the non-IPv6 data packet, and store the first rules into the storage system of the router, wherein the first rules comprise:
(1). If the non-IPv6 data packet is from the WAN port of the router, the router routes the non-IPv6 data packet;
(2). If the non-IPv6 data packet is to the WAN port, but the non-IPv6 data packet is neither a multicast data packet nor a broadcast data packet, the router routes the non-IPv6 data packet; and
(3). If the non-IPv6 data packet is to the WAN port, and the non-IPv6 data packet is a multicast data packet or a broadcast data packet, the router filters the non-IPv6 data packet.

17. The router as described in claim 16, wherein the routing module further operable to filter the data packet according to the first rules.

18. The router as described in claim 15, further comprising:
a rule establishment module operable to establish second rules of the router for processing the IPv6 data packet, and storing the second rules into a storage system of the router, wherein the second rules comprise: passing unicast data packets to a wireless LAN port of the router, while filtering multicast data packets, passing internet control message protocol (ICMP) data packets, while filtering user datagram protocol (UDP) data packets.

19. The router as described in claim 18, wherein the bridging module further operable to filter the data packet according to the second rules.

20. The router as described in claim 15, the bridging functionality is enabled by tying the LAN port and the WAN port of the router to a Bridge.
